(19) United States
(12) Patent Application Publication
(10) Pub. No.: US 2022/0154959 A1
(43) Pub. Date: May 19, 2022

(54) AIR CONDITIONING CONTROL DEVICE, AIR CONDITIONING CONTROL SYSTEM, AIR CONDITIONING CONTROL METHOD, AND TERMINAL DEVICE

(71) Applicant: TOYOTA JIDOSHA KABUSHIKI KAISHA, Aichi-ken (JP)

(72) Inventor: Takumi SHIBANO, Nagoya-shi (JP)

(21) Appl. No.: 17/405,033

(22) Filed: Aug. 18, 2021

(30) Foreign Application Priority Data
Nov. 18, 2020 (JP) 2020-192035

(51) Int. Cl. F24F 11/63; F24F 11/58; F24F 11/52; G05B 13/02

(52) U.S. Cl. CPC F24F 11/63; F24F 11/58; F24F 2120/00; G05B 13/021; F24F 11/52

(57) ABSTRACT

An air conditioning control device includes a control unit for controlling an air conditioning apparatus installed in a destination, based on user information relating to a user that moves to the destination.

### CROSS-REFERENCE TO RELATED APPLICATION

This application claims priority to Japanese Patent Application No. 2020-192035 filed on Nov. 18, 2020, incorporated herein by reference in its entirety.

### BACKGROUND

### 1. Technical Field

The present disclosure relates to an air conditioning control device, an air conditioning control system, an air conditioning control method, and a terminal device.

### 2. Description of Related Art

Conventionally, a method of controlling an air conditioning apparatus based on the user's sensible temperature is known. For example, Japanese Unexamined Patent Application Publication No. 2019-202689 (JP 2019-202689 A) discloses a technology that calculates a user's sensible temperature from weather information of a place visited by the user, and notifies a set temperature of the air conditioning apparatus to a vehicle based on the user's sensible temperature.

### SUMMARY

Improvement of the comfort in the destination as well as the comfort during movement of the user is required.

The purpose of the present disclosure made in view of such circumstances is to improve the comfort of the user in the destination.

An air conditioning control device according to a first aspect of the present disclosure includes a control unit for controlling an air conditioning apparatus installed in a destination, based on user information relating to a user that moves to the destination.

An air conditioning control system according to a second aspect of the present disclosure includes the air conditioning control device and a terminal device possessed by the user.

An air conditioning control method according to a third aspect of the present disclosure includes controlling an air conditioning apparatus installed in a destination, based on user information relating to a user that moves to the destination.

A terminal device according to a fourth aspect of the present disclosure includes a control unit for acquiring user information relating to a user that moves to a destination, and outputting the user information to an air conditioning control device for controlling an air conditioning apparatus installed in the destination.

With the air conditioning control device, the air conditioning control system, the air conditioning control method, and the terminal device according to each aspect of the present disclosure, the comfort of the user at the destination can be improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic view showing a configuration example of an air conditioning control system according to an embodiment;

FIG. 2 is a block diagram showing a configuration example of the air conditioning control system according to the embodiment; and

FIG. 3 is a flowchart showing a procedure example of an air conditioning control method according to the embodiment.

### DETAILED DESCRIPTION OF EMBODIMENTS

### Configuration Example of Air Conditioning Control System 1

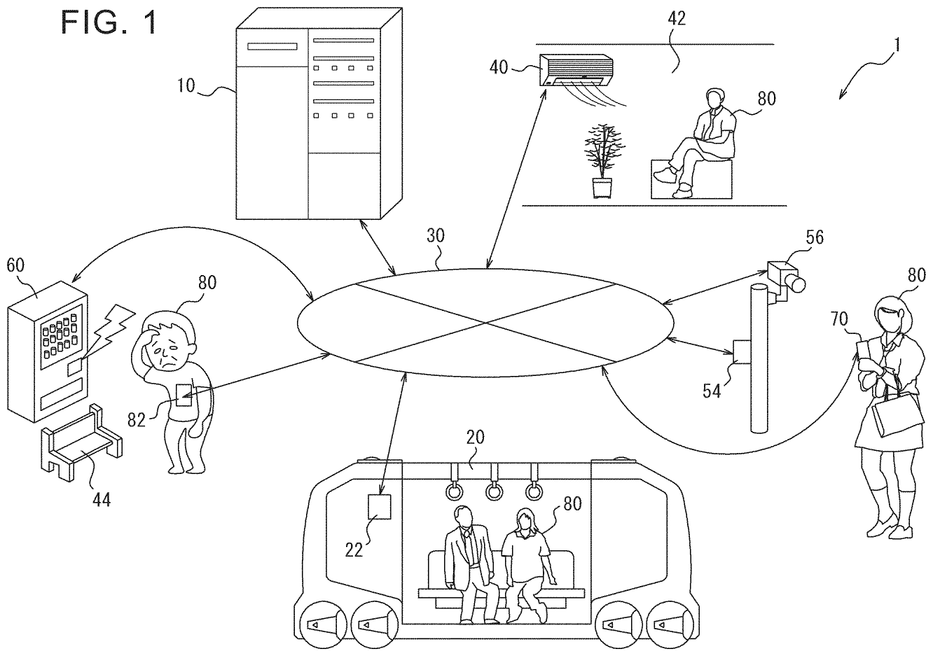

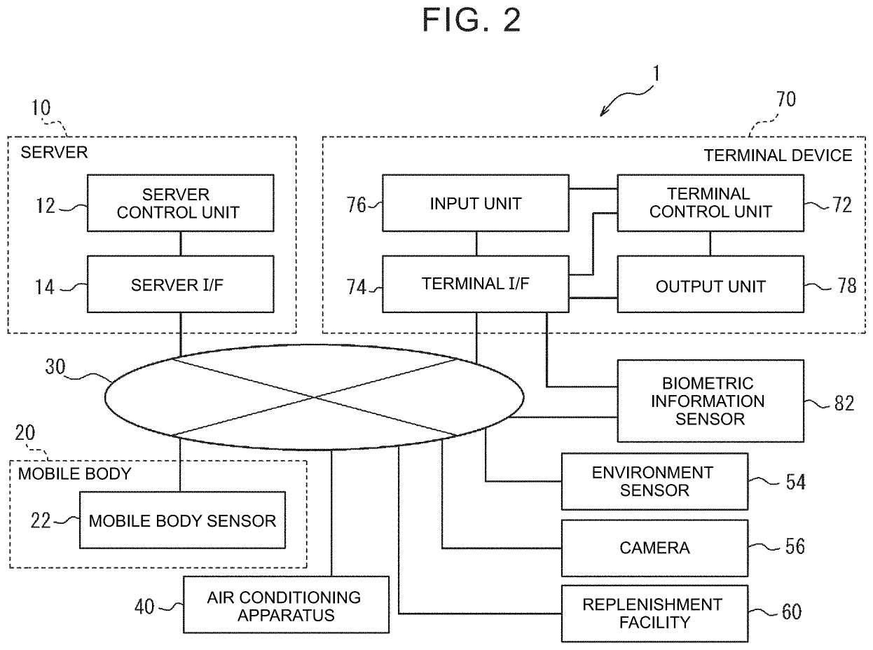

As shown in FIGS. 1 and 2, an air conditioning control system 1 according to an embodiment includes a server 10 and an air conditioning apparatus 40. The air conditioning apparatus 40 adjusts the temperature, humidity, or the like of the space used by a user 80. The air conditioning control system 1 controls the air conditioning apparatus 40 by the server 10. The server 10 controls the air conditioning apparatus 40 based on the information relating to the user 80. The information relating to the user 80 is also referred to as user information. When the air conditioning apparatus 40 is controlled based on the user information, the user 80 can comfortably use the space.

In the present embodiment, it is assumed that the user 80 is moving to the space in which the air conditioning apparatus 40 to be controlled is installed, as a destination. That is, the air conditioning control system 1 controls the air conditioning apparatus 40 installed in the destination of the user 80 that is moving. The destination may include a home 42 of the user 80, an office at which the user 80 is working, or the like. The destination may include a stop-off point of the user 80. The destination may include a plurality of points.

The air conditioning control system 1 may control the air conditioning apparatus 40 installed in the destination, based on the user information of the user 80 before arriving at the destination. Further, the air conditioning control system 1 may control the air conditioning apparatus 40 installed in the destination to which the user 80 moves, based on the user information of the user 80 that is moving to the destination. In this way, when the user 80 arrives at the destination, the temperature, humidity, etc. of the space can be appropriately adjusted based on the user information. As a result, the comfort of the user 80 can be improved. Hereinafter, a configuration example of the air conditioning control system 1 will be described.

### Server 10

The server 10 includes a server control unit 12 and a server interface 14. The server interface 14 is also referred to as the server I/F 14.

The server control unit 12 controls each component of the server 10. The server control unit 12 is also simply referred to as a control unit. The server control unit 12 may be configured to include one or more processors. According to the embodiment, the “processor” is a general-purpose processor or a dedicated processor specialized for specific processing. However, the processor is not limited thereto. The server control unit 12 may be configured to include one or more dedicated circuits. The dedicated circuit may include, for example, a field-programmable gate array (FPGA) or an application-specific integrated circuit (ASIC). The server control unit 12 may be configured to include the dedicated circuit instead of the processor, or may be configured to include the dedicated circuit together with the processor.

The server 10 may further include a storage unit. The storage unit is, for example, a semiconductor memory, a magnetic memory, or an optical memory. However, the storage unit is not limited thereto. The storage unit may function as, for example, a main storage device, an auxiliary storage device, or a cache memory. The storage unit may include an electromagnetic storage medium such as a magnetic disk. The storage unit may include a non-transitory computer-readable medium. The storage unit stores arbitrary information used for the operation of the server 10. The storage unit may store, for example, a system program, an application program, or the like. The storage unit may be included in the server control unit 12.

The server I/F 14 outputs information, data, or the like from the server control unit 12, or inputs information, data, or the like to the server control unit 12. The server I/F 14 is also simply referred to as an interface or I/F.

The server I/F 14 may include a communication module configured to be communicable with other apparatuses such as the air conditioning apparatus 40 via a network 30. For example, the communication module may conform to mobile communication standards such as the fourth generation (4G) and the fifth generation (5G). The communication module may conform to communication standards such as local area network (LAN). The communication module may conform to a wired or wireless communication standard. The communication module is not limited to this and may conform to various communications standards. The server I/F 14 may be configured to be connectable to the communication module.

The server I/F 14 may include an input device that receives input of information, data, or the like from the user 80. The input device may be configured to include, for example, a touch panel or a touch sensor, or a pointing device such as a mouse. The input device may be configured to include a physical key. The input device may be configured to include an audio input device such as a microphone. The server I/F 14 may be configured to be connectable to the input device. The server I/F 14 may output the input information as the user information to the server control unit 12.

The server I/F 14 may include an output device that outputs information, data, or the like to the user 80. The output device may include, for example, a display device that outputs visual information such as images, characters, or figures. The display device may be configured to include, for example, a liquid crystal display (LCD), an organic electro-luminescence (EL) display or an inorganic EL display, a plasma display panel (PDP), or the like. The display device is not limited to the displays above, and may be configured to include various other types of displays. The display device may be configured to include a light emitting device such as a light emission diode (LED) or a laser diode (LD). The display device may be configured to include various other devices. The output device may include, for example, an audio output device such as a speaker that outputs auditory information such as audio. The output device is not limited to the examples above, and may include various other devices. The server I/F 14 may be configured to be connectable to the output device.

The server 10 may include one server device or a plurality of server devices communicable with each other. The server 10 is also referred to as an air conditioning control device.

### Air Conditioning Apparatus 40

The air conditioning apparatus 40 is installed in a space used by the user 80. The air conditioning apparatus 40 may be installed in a room, such as a living room, in the home 42 of the user 80. The air conditioning apparatus 40 may be installed in an office where the user 80 works, or the like. The number of air conditioning apparatuses 40 is not limited to one and may be two or more.

### Terminal Device 70

The air conditioning control system 1 further includes a terminal device 70, although it is not essential. The terminal device 70 is possessed by the user 80. The terminal device 70 may include a mobile terminal such as a smartphone. The terminal device 70 may include a personal computer (PC) such as a laptop PC or a tablet PC. The terminal device 70 is not limited to the examples above, and may be configured to include various devices.

The terminal device 70 includes a terminal control unit 72 and a terminal interface 74. The terminal interface 74 is also referred to as the terminal I/F 74.

The terminal control unit 72 controls each component of the terminal device 70. The terminal control unit 72 is also simply referred to as a control unit. The terminal control unit 72 may be configured to be the same as or similar to the server control unit 12 of the server 10. The terminal control unit 72 may be configured to include one or more processors. The terminal control unit 72 may be configured to include one or more dedicated circuits. The dedicated circuit may be, for example, an FPGA or an ASIC. The terminal control unit 72 may be configured to include the dedicated circuit instead of the processor, or may be configured to include the dedicated circuit together with the processor.

The terminal device 70 may further include a storage unit. The storage unit of the terminal device 70 may be configured to be the same as or similar to the storage unit of the server 10. The storage unit is, for example, a semiconductor memory, a magnetic memory, or an optical memory. However, the storage unit is not limited thereto. The storage unit may function as, for example, a main storage device, an auxiliary storage device, or a cache memory. The storage unit may include an electromagnetic storage medium such as a magnetic disk. The storage unit stores arbitrary information that is used for operation of the terminal device 70. The storage unit may store, for example, a system program, an application program, or the like. The storage unit may be included in the terminal control unit 72.

The terminal I/F 74 outputs information, data, or the like from the terminal control unit 72, or inputs information, data, or the like to the terminal control unit 72. The terminal I/F 74 is also simply referred to as an interface or I/F.

The terminal I/F 74 may be configured to be the same as or similar to the server I/F 14. The terminal I/F 74 may include a communication module configured to be communicable with the mobile body 20 via a network 30. The communication module may include a communication module conforming to mobile communication standards such as the 4G or the 5G. However, the communication module is not limited thereto. The terminal I/F 74 may be configured to be connectable to the communication module.

The terminal device 70 further includes an input unit 76, although it is not essential. The input unit 76 may be configured to include an input device that receives input of information, data, or the like from the user 80. The input device may be configured to include, for example, a touch panel or a touch sensor, or a pointing device such as a mouse. The input device may be configured to include a physical key. The input device may be configured to include an audio input device such as a microphone. The input device may be configured to be the same as or similar to the input device included in the server I/F 14.

The input unit 76 may be configured to include sensors that detect various types of information relating to the user 80. The sensor may detect information relating to the environment around the user 80, for example, as the user information. The information relating to the environment around the user 80 is also referred to as environment information. The environment information may include, for example, temperature or humidity, or the amount of sunshine. The sensor may detect the positional information of the user 80, for example. The terminal device 70 may output the detected information as the user information to the server 10 by the terminal I/F 74.

The terminal device 70 further includes an output unit 78, although it is not essential. The output unit 78 may include an output device that outputs information, data, or the like to the user 80. The output device may include, for example, a display device that outputs visual information such as images, characters, or figures. The output device may include, for example, an audio output device such as a speaker that outputs auditory information such as audio. The output device is not limited to the examples above, and may include various other devices. The output device may be configured to be the same as or similar to the output device included in the server I/F 14.

The number of terminal devices 70 provided by the air conditioning control system 1 is not limited to one, and may be two or more.

### Mobile Body 20

The air conditioning control system 1 further includes a mobile body 20, although it is not essential. The user 80 uses the mobile body 20 to move to the destination.

The mobile body 20 further includes a mobile body sensor 22. The mobile body sensor 22 may include a sensor for detecting temperature, humidity, or the like within the mobile body 20. The mobile body sensor 22 may include an imaging sensor for capturing an image of the user 80 riding on the mobile body 20. The mobile body sensor 22 may be configured to be communicable with the server 10 via the network 30 and may output the detected information to the server 10 as the user information.

The number of mobile bodies 20 in the air conditioning control system 1 is not limited to one, and may be two or more. The mobile body 20 may be moved by driving or operation of the user 80. The mobile body 20 may be moved by autonomous driving or automatic operation. When the mobile body 20 is a vehicle, the autonomous driving may be performed at any level from level 1 to level 5 defined by, for example, the Society of Automotive Engineers (SAE). The autonomous driving is not limited to the exemplified definition, and may be performed based on other definitions.

The mobile body 20 may further include a position information acquisition unit. The position information acquisition unit acquires position information of the mobile body 20 itself. The position information acquisition unit may include a receiver compatible with the satellite positioning system. The receiver compatible with the satellite positioning system may include, for example, a global positioning system (GPS) receiver. The mobile body 20 may output, to the server 10, the position information of the mobile body 20 itself acquired by the position information acquisition unit. The mobile body 20 may further include a mobile body control unit that controls the autonomous driving based on the position information of the mobile body 20.

### Other Configurations

The air conditioning control system 1 further includes an environment sensor 54 that detects environment information in the path along which the user 80 moves, although it is not essential. The environment sensor 54 may include a sensor for detecting, for example, temperature or humidity, or the amount of sunshine. The environment sensor 54 may be configured to be communicable with the server 10 via the network 30 and may output the detected environment information to the server 10 as the user information.

The air conditioning control system 1 further includes a camera 56 that captures an image of the user 80 in the path along which the user 80 moves, although it is not essential. The camera 56 may capture an image of the appearance of the user 80 by detecting visible light. The camera 56 may capture thermography images of the user 80 by detecting infrared light. The camera 56 may be configured to be communicable with the server 10 via the network 30, and may output the captured image to the server 10 as the user information. The camera 56 may measure the temperature of the body surface of the user 80 or estimate the deep body temperature of the user 80 based on the thermography image when the thermography image of the user 80 is captured. The camera 56 may output a measured value of the temperature of the body surface or an estimated value of the deep body temperature to the server 10 as biometric information of the user 80. The camera 56 may estimate the mood or symptom of the user 80 by analyzing the expression, movement, or the like of the user 80, and output the estimated result to the server 10 as the user information or the biometric information of the user 80.

The air conditioning control system 1 further includes a user-worn sensor 82, although it is not essential. The user-worn sensor 82 may be configured as a wearable sensor worn by the user 80. The user-worn sensor 82 may include a smartwatch, for example. The user-worn sensor 82 detects the biometric information of the user 80. The user-worn sensor 82 may detect various types of biometric information including, for example, body temperature, perspiration, respiration rate, blood pressure, or heart rate of the user 80. The user-worn sensor 82 may be configured to be communicable with the server 10 via the network 30 and may output the detected biometric information to the server 10 as the user information. The user-worn sensor 82 may detect the position information of the user 80 and output the position information to the server 10 as the user information.

The air conditioning control system 1 further includes a replenishment facility 60, although it is not essential. The replenishment facility 60 may be installed on a path along which the user 80 moves, or may be installed off the path. The replenishment facility 60 may be configured as a beverage or food vending machine, for example. The replenishment facility 60 may be configured as a drinking-water facility, such as a water cooler, for example. The replenishment facility 60 may include an output device configured to be able to notify the user 80 of information. The replenishment facility 60 may be configured to be communicable with the server 10 via the network 30 and may notify the user 80 of information acquired from the server 10 by the output device.

### Operation Example of Air Conditioning Control System 1

In the air conditioning control system 1, the server 10 controls the air conditioning apparatus 40 installed in the destination of the user 80. Further, the server 10 may control the air conditioning apparatus 40 based on the user information until arriving at the destination. Hereinafter, a specific example of the operation of the server 10 controlling the air conditioning apparatus 40 is described.

The server control unit 12 of the server 10 acquires information relating to a destination of the user 80. The information relating to the destination of the user 80 is also referred to as destination information. The server control unit 12 may acquire, as the destination information, information that specifies the destination point of the moving user 80 or the user 80 that will start moving. The server control unit 12 may acquire, as the destination information, information that specifies a point at which the user 80 stops while moving.

The server control unit 12 may acquire the destination information from the terminal device 70 via the server I/F 14. The server control unit 12 may receive input of the destination information from the user 80 by the input device included in the server I/F 14.

The server control unit 12 acquires the user information. The server control unit 12 may acquire user information from various devices or sensors via the server I/F 14 or without the server I/F 14.

The server control unit 12 may acquire the environment information as the user information. The server control unit 12 may acquire the environment information from various devices such as the terminal device 70 possessed by the user 80. When the user 80 is moving while riding on the mobile body 20, the server control unit 12 may acquire the environment information from the mobile body sensor 22 mounted on the mobile body 20. When the user 80 is moving on foot, the server control unit 12 may acquire the environment information from various sensors, such as the environment sensor 54 or the camera 56, that are installed in a path along which the user 80 moves on foot. The server control unit 12 may acquire the environment information from various sensors such as the user-worn sensor 82 worn by the user 80.

The server control unit 12 may acquire the biometric information of the user 80 as the user information. The server control unit 12 may acquire the biometric information from various devices such as the terminal device 70 possessed by the user 80. The server control unit 12 may acquire the biometric information from various sensors such as the user-worn sensor 82 worn by the user 80.

When the user 80 is moving while riding on the mobile body 20, the server control unit 12 may acquire the biometric information of the user 80 from a position away from the user 80 by the mobile body sensor 22 mounted on the mobile body 20. When the user 80 is moving on foot, the server control unit 12 may acquire the biometric information of the user 80 from a position away from the user 80 by capturing an image of the user 80 with the camera 56. When acquiring the biometric information from a position away from a person such as the user 80, the server control unit 12 may associate the acquired biometric information with the user 80 by authenticating that the person is the user 80. The server control unit 12 may associate the acquired biometric information with the user 80 when the image of the face of the target person to acquire the biometric information is acquired and the person is authenticated as the user 80.

The server control unit 12 may acquire the destination information of the user 80 based on the user information. That is, the server control unit 12 may acquire the user information prior to the destination information. The server control unit 12 may acquire, for example, the position information of the user 80 as the user information. The server control unit 12 may calculate the moving path or the moving speed of the user 80 based on the position information of the user 80. The server control unit 12 may estimate a location where the user 80 may stay, including, for example, a point where the user 80 may rest during movement or a building such as a store where the user 80 may stop, based on the position information of the user 80. The server control unit 12 may acquire, as the user information, the estimated result of information relating to a location where the user 80 may stay.

The server control unit 12 may estimate whether the user 80 stays at a predetermined point, a building, or the like for a predetermined time or more based on the user information. When the server control unit 12 estimates that the user 80 stays at a predetermined point, a building, or the like for a predetermined time or more, the server control unit 12 may estimate the point, the building, or the like where the user 80 is estimated to stay for a predetermined time or more as one of the destinations of the user 80, and may acquire the estimated result of the destination as the destination information.

The server control unit 12 estimates the state of the user 80 based on the user information. The server control unit 12 may estimate the time required for the user 80 to arrive at the destination, as the state of the user 80. The server control unit 12 may estimate, for example, whether the user 80 feels hot or cold. The server control unit 12 may estimate the state the user 80 is experiencing. The server control unit 12 may estimate the physical condition or health condition of the user 80 as the state of the user 80. The server control unit 12 may estimate whether the user 80 needs to be warmed or the user 80 needs to be cooled regardless of the state the user 80 is experiencing. For example, the server control unit 12 may estimate whether the user 80 is in a state in which it is necessary to cool the body due to heat stroke or the like based on the body temperature of the user 80. When it is necessary to cool the body of the user 80, the server control unit 12 may further lower the target temperature of the air conditioning apparatus 40. The server control unit 12 may estimate whether the user 80 is in a state in which it is necessary to warm the body due to low body temperature or the like, based on the body temperature of the user 80 When it is necessary to warm the body of the user 80, the server control unit 12 may further increase the target temperature of the air conditioning apparatus 40.

The server control unit 12 controls the air conditioning apparatus 40 installed in the destination of the user 80 based on the state of the user 80. For example, the server control unit 12 may determine a time at which the operation of the air conditioning apparatus 40 is started based on an estimated value of the time required for the user 80 to arrive at the destination. The server control unit 12 may lower the target temperature of the air conditioning apparatus 40 installed in the destination of the user 80, for example, when the server control unit 12 estimates that the user 80 is feeling hot or when the server control unit 12 estimates that the user 80 needs to be cooled. The server control unit 12 may increase the target temperature of the air conditioning apparatus 40 installed in the destination of the user 80, for example, when the server control unit 12 estimates that the user 80 is feeling cold or when the server control unit 12 estimates that the user 80 needs to be warmed. Further, the server control unit 12 can set the target temperature of the air conditioning apparatus 40 within a predetermined range based on the state of the user 80. With the target temperature of the air conditioning apparatus 40 set within a predetermined range, excessive consumption of energy such as electric power by the air conditioning apparatus 40 can be avoided. That is, energy can be used efficiently.

The destination of the user 80 may be set at not only at one location but also at two or more locations. The server control unit 12 may control the air conditioning apparatus 40 installed in each destination based on the user information. The number of air conditioning apparatuses 40 installed in one destination of the user 80 is not limited to one and may be two or more. The server control unit 12 may control each air conditioning apparatus 40 installed in the destination independently or in conjunction with each other based on the user information.

### Procedure Example of Air Conditioning Control Method

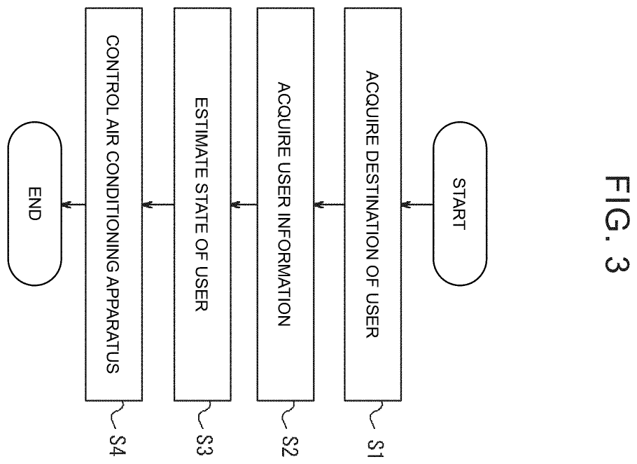

The server control unit 12 may execute an air conditioning control method including the procedure of a flowchart illustrated in FIG. 3. The air conditioning control method may be realized as an air conditioning control program executed by a processor constituting the server control unit 12. The air conditioning control program can be stored in a non-transitory computer-readable medium.

The server control unit 12 acquires the information relating to the destination of the user 80 (step S1). Specifically, the server control unit 12 may receive input on the destination of the user 80 in the server I/F 14. The server control unit 12 may acquire, from the terminal device 70, the information relating to the destination input to the terminal device 70. The method of acquiring of the information relating to the destination of the user 80 is not limited to these examples, and the server control unit 12 may acquire information relating to the destination of the user 80 by various means.

The server control unit 12 acquires the user information (step S2). Specifically, the server control unit 12 may acquire information input to the server I/F 14 as the user information. The server control unit 12 may acquire information detected by the terminal device 70 as the user information. The server control unit 12 may acquire information detected by the environment sensor 54 or the user-worn sensor 82, or an image captured by the camera 56 as the user information.

The server control unit 12 estimates the state of the user 80 (step S3). Specifically, the server control unit 12 estimates the state of the user 80 based on the user information. The server control unit 12 may estimate, for example, the health state of the user 80 based on the biometric information of the user 80. The server control unit 12 may estimate, for example, how the user 80 feels the temperature, that is, whether the user 80 feels hot or cold based on the environment information.

The server control unit 12 controls the air conditioning apparatus 40 (step S4). Specifically, the server control unit 12 generates control information of the air conditioning apparatus 40 based on the estimated result of the state of the user 80, and outputs the control information to the air conditioning apparatus 40. The server control unit 12 may determine a target temperature for controlling the temperature of the destination of the user 80 as the control information. For example, the server control unit 12 may determine a target temperature of the destination of the user 80 based on the estimation result of the health state of the user 80.

After executing the procedure in step S4, the server control unit 12 ends the execution of the procedure of the flowchart shown in FIG. 3.

As described above, in the air conditioning control system 1 according to the present embodiment, the server 10 controls the air conditioning apparatus 40 installed in the destination of the user 80, based on the user information. In this way, the comfort of the user 80 that has arrived at the destination can be improved.

Further, the air conditioning control system 1 according to the present embodiment can control the air conditioning apparatus 40 based on the action of people such as the user 80. Further, the air conditioning control system 1 can control the air conditioning apparatus 40 by utilizing information or data detected by various sensors installed in the city where people such as the user 80 perform activities, residences, or the like. The control of the air conditioning apparatus 40 can enhance the comfort of lives of people such as the user 80. Further, energy can be used efficiently.

### Other Embodiments

### Providing Replenishment Information to User 80

The server control unit 12 may estimate, as the state of the user 80, for example, whether the user 80 is in a state in which the user 80 requires replenishment of water or salinity as in the dehydrated state. When the server control unit 12 estimates that the user 80 needs to be replenished, the server control unit 12 may generate information for notifying the user 80 of the need for replenishment such as water or salinity, and notify the user 80 of the information. The information notifying the need for replenishment to the user 80 is also referred to as replenishment information. The server control unit 12 may output the replenishment information to the terminal device 70 possessed by the user 80, and may notify the user 80 via the terminal device 70. With the notification of the replenishment information, the convenience of the user 80 can be improved.

The replenishment information may include information relating to the type of replenishment proposed to the user 80. For example, the replenishment information may include information suggesting hydration to the user 80 or may include information suggesting salinity or mineral supplementation.

The replenishment information may include information relating to the replenishment facility 60 that is configured to be capable of providing replenishment to the user 80. The replenishment facility 60 may be installed in a path along which the user 80 moves or may be installed at a position off the path. The replenishment information may include information identifying the set location of the replenishment facility 60. The replenishment information may include information identifying the type of replenishment provided by the replenishment facility 60.

The server control unit 12 may output the replenishment information to the replenishment facility 60 and may cause the replenishment facility 60 to notify the replenishment information to the user 80 approaching a predetermined range of the replenishment facility 60. The replenishment facility 60 may include an output device such as a speaker, display, or light, to be able to notify the user 80 of the replenishment information. The server control unit 12 may cause the replenishment facility 60 to provide replenishment supplies to the user 80. By notifying the user 80 from the replenishment facility 60, the convenience of the user 80 can be improved.

The server control unit 12 may acquire registration information of the user 80 in advance and notify the registered user 80 of the replenishment information. The server control unit 12 may cause the replenishment facility 60 to provide the registered user 80 with the replenishment supplies as necessary, and output information to request the charge of the replenishment supplies to the user 80 after the provision. The server control unit 12 may output the information to request the charge of the replenishment supplies to the terminal device 70 possessed by the user 80. The server control unit 12 may provide a service for providing the replenishment supplies from the replenishment facility 60 to the user 80 as a flat-rate service. Since compensation is not requested at the time the replenishment supplies are provided, it is easier for the user 80 to receive the replenishment supplies. As a result, the convenience of the user 80 can be improved.

### Providing Rest Information to User 80

The server control unit 12 may estimate, as the state of the user 80, for example, whether the user 80 needs a rest. When the server control unit 12 estimates that the user 80 needs a rest, the server control unit 12 may generate information to notify the user 80 of the need for a rest and notify the user 80. The information informing the user 80 of the need for a rest is also referred to as rest information. The server control unit 12 may output the rest information to the terminal device 70 possessed by the user 80, and notify the user 80 from the terminal device 70.

The rest information may include information identifying a rest place 44, such as a bench, that allows the user 80 to rest. The rest information may include information relating to the rest place 44 where the replenishment facility 60 is located. The rest information may be included in the replenishment information. The server control unit 12 may output the rest information to the replenishment facility 60 installed in the rest place 44 and cause the replenishment facility 60 to notify the rest information to the user 80 that has approached a predetermined range of the rest place 44. In this way, the convenience of the user 80 may be improved.

The rest place 44 may be configured as a space in which the air conditioning apparatus 40 is installed, such as waiting room or the like of a station. The server control unit 12 may add the rest place 44 specified by the rest information notified to the user 80 to the destination of the user 80. The server control unit 12 may control the air conditioning apparatus 40 installed in the rest place 44 specified by the rest information notified to the user 80, based on the information relating to the user 80. In this way, the convenience of the user 80 can be enhanced.

### Control of Air Conditioning Apparatus 40 Based on Action at Destination

The server control unit 12 may control the air conditioning apparatus 40 installed in the destination based further on the action of the user 80 after arriving at the destination. For example, when the user 80 performs the work of hanging the laundry in the room after arriving at the home 42 as a destination, the server control unit 12 may lower the target humidity or increase the target temperature of the air conditioning apparatus 40 so that the laundry is easily dried. The comfort of the user 80 can be further enhanced by the control of the air conditioning apparatus 40 based on actions taken after the user 80 has arrived at the destination.

### Control of Air Conditioning Apparatus 40 After Departure

The server control unit 12 can adjust the temperature, humidity, or the like of the destination by controlling the air conditioning apparatus 40 installed in the destination until the user 80 arrives at the destination. After the user 80 leaves a certain location, the server control unit 12 may change the control of the air conditioning apparatus 40 installed in the departing location. Specifically, the server control unit 12 may change the target temperature of the air conditioning apparatus 40 based on the information of the user 80 remaining in the departing location. In this way, the convenience of the user 80 can be enhanced. Further, the server control unit 12 may stop or lower the output of the air conditioning apparatus 40 installed in the place where the user 80 departs. In this way, energy can be saved.

Although the embodiment according to the present disclosure has been described above based on the drawings and examples, it should be noted that those skilled in the art can easily make various modifications and alterations thereto based on the present disclosure. It should be noted, therefore, that these modifications and alterations are within the scope of the present disclosure. For example, the functions or the like, included in each means, step, or the like, can be rearranged without causing logical inconsistency, and a plurality of means, steps, or the like, can be integrated into unity or can be divided.

What is claimed is:

1. An air conditioning control device comprising a control unit for controlling an air conditioning apparatus installed in a destination, based on user information relating to a user that moves to the destination.

2. The air conditioning control device according to claim 1, wherein the control unit estimates a point where the user stays for a predetermined time or more as the destination, based on the user information.

3. The air conditioning control device according to claim 1, wherein the control unit acquires environment information relating to an environment around the user as the user information.

4. The air conditioning control device according to claim 3, wherein the control unit acquires the environment information from a terminal device possessed by the user.

5. The air conditioning control device according to claim 3, wherein when the user is moving by a mobile body, the control unit acquires the environment information from a sensor of the mobile body.

6. The air conditioning control device according to claim 3, wherein the control unit acquires the environment information from a sensor installed in a path along which the user is moving.

7. The air conditioning control device according to claim 1, wherein the control unit acquires biometric information of the user as the user information.

8. The air conditioning control device according to claim 7, wherein the control unit acquires the biometric information from a terminal device possessed by the user.

9. The air conditioning control device according to claim 7, wherein the control unit acquires the biometric information from a sensor that the user wears on a body.

10. The air conditioning control device according to claim 7, wherein the control unit acquires the biometric information from a camera or thermography for capturing an image of the user.

11. The air conditioning control device according to claim 1, wherein the control unit estimates a state of the user based on the user information, and further controls the air conditioning apparatus installed in the destination, based on an estimated result of the state of the user.

12. The air conditioning control device according to claim 11, wherein the control unit determines a rest place to propose to the user based on the estimated result of the state of the user, and controls the air conditioning apparatus installed in the rest place, based on the estimated result of the state of the user.

13. The air conditioning control device according to claim 11, wherein the control unit outputs replenishment information for notifying a need for replenishment to the user, based on the estimated result of the state of the user.

14. The air conditioning control device according to claim 13, wherein the control unit outputs the replenishment information to a terminal device possessed by the user.

15. The air conditioning control device according to claim 13, wherein the control unit outputs the replenishment information to a replenishment facility configured to be able of providing replenishment supplies to the user.

16. The air conditioning control device according to claim 15, wherein the control unit outputs information for requesting a charge of the replenishment supplies to the user, when the replenishment facility provides the replenishment supplies to the user.

17. An air conditioning control system comprising the air conditioning control device and the air conditioning apparatus according to claim 1.

18. An air conditioning control method comprising controlling an air conditioning apparatus installed in a destination, based on user information relating to a user that moves to the destination.

19. A terminal device comprising a control unit for acquiring user information relating to a user that moves to a destination, and outputting the user information to an air conditioning control device for controlling an air conditioning apparatus installed in the destination.

20. The terminal device according to claim 19, wherein the control unit acquires, from the air conditioning control device, replenishment information for notifying a need for replenishment of water or salinity to the user and notifies the user of the replenishment information.
